(19) United States
(12) Patent Application Publication
(10) Pub. No.: US 2015/0260920 A1
(43) Pub. Date: Sep. 17, 2015

(54) OPTICAL PATH CONTROL DEVICE

(71) Applicant: SUMITOMO ELECTRIC INDUSTRIES, LTD., Osaka (JP)

(72) Inventor: Takafumi Ohtsuka, Yokohama-shi (JP)

(21) Appl. No.: 14/436,438

(22) PCT Filed: Oct. 16, 2012
(86) PCT No.: PCT/JP2012/076717

§ 371 Date: Apr. 16, 2015

(51) Int. Cl. G02B 6/35; G02B 6/27

(52) U.S. Cl. CPC G02B 6/3546; G02B 6/3518; G02B 6/2773; G02B 6/3532

(57) ABSTRACT

In an optical path control device 100, dispersed lights L2 in a flat shape in which a spot size in an arrangement direction (y-axis direction) of light deflection component elements to deflect light is relatively larger enter a light deflection element 7 and thus, the dispersed lights L2 can be deflected precisely and efficiently. Particularly in the optical path control device 100, the spot size thereof is converted by an anamorphic converter 2 arranged prior to the dispersive element 5. Thus, the degree of flexibility of optical design can be increased such as being able to arrange various optical components subsequent to the dispersive element 5.

### TECHNICAL FIELD

The present invention relates to, for example, an optical device such as a wavelength selection switch.

### BACKGROUND ART

A wavelength selection operation device is described in Patent Literature 1. The wavelength selection operation device includes an input/output fiber, a spherical minor, a cylindrical lens, a diffraction grating, and an LCD (Liquid Crystal Device). The input/output fiber is arranged in the x direction. Light from the input/output fiber enters the diffraction grating after being reflected by the spherical minor and collimated. The light having entered the diffraction grating is angle-dispersed in the y direction in accordance with the wavelength component and is emitted. The light having been emitted from the diffraction grating is condensed in the x direction and also collimated in the y direction by passing through the cylindrical lens and is reflected by the spherical minor again. The light having been reflected by the spherical minor again is collimated in the x direction and also condensed in the y direction by passing through the cylindrical lens again and then enters the LCD.

### CITATION LIST

### Patent Literature

[Patent Literature 1] U.S. Pat. No. 7,092,599

### SUMMARY OF INVENTION

As a light deflection element of the wavelength selection switch, LCOS (Liquid Crystal On Silicon) as a reflection-type liquid crystal may be used. LCOS is a light deflection element that uses a plurality of spatially discretized pixels. Thus, to deflect light efficiently and precisely by using LCOS, many pixels should be used simultaneously. Therefore, regarding the port selection axis direction (for example, the arrangement direction of the input/output port), a larger spot size of an optical beam with which LCOS is irradiated is preferable.

In the wavelength selection switch, by contrast, a high wavelength resolution is needed and as long as the number of pixels of LCOS is finite, it is necessary to make the spot size of an optical beam in the wavelength selection direction (for example, the dispersive direction of the diffraction grating) smaller to some extent. That is, compared with the spot size in the wavelength selection axis direction, it is desirable to make the spot size in the port selection axis direction larger (that is, to increase the aspect ratio) on the light deflection element such as LCOS.

In the wavelength selection operation device described in the aforementioned Patent Literature 1, the spot size in each direction is changed by repeating condensing and collimation in the x direction and y direction subsequent to the diffraction grating thereby the aspect ratio of spot sizes on LCD is relatively increased. In the wavelength selection operation device described in Patent Literature 1, however, optical systems for condensing and collimation are arranged subsequent to the diffraction grating and therefore, the degree of flexibility of optical design is low such as difficulty to arrange various optical components subsequent to the diffraction grating.

An aspect of the present invention relates to an optical device. The optical device comprising; a first element including an input port for inputting wavelength multiplexed light; a second element including third and fourth elements and converting an aspect ratio of a beam spot of the wavelength multiplexed light; the third element including first and second optical power elements for converging the wavelength multiplexed light in a first plane that extends in a propagation direction of the light and a first direction; the fourth element including a third optical power element for collimating the wavelength multiplexed light in a second plane that extends in the propagation direction of the light and a second direction perpendicular to the first direction; a fifth element generating a plurality of dispersed lights by rotating the propagation direction of the light around an axis along the first direction in the second plane in accordance with each wavelength; a sixth element including a fourth optical power element for converging each of the dispersed lights and making the propagation directions of the plurality of dispersed lights parallel in the second plane; a seventh element deflecting each of the dispersed lights in the first plane by rotating the propagation direction around an axis along a third direction perpendicular to the first direction, and including a plurality of pixelized light deflection elements arranged in the first direction for independently modulating each of the dispersed lights; an eighth element including a fifth optical power element for deflecting, in a third plane that extends in the propagation direction of the light and the third direction, each of the dispersed lights emitted from the seventh element by rotating around an axis along a fourth direction perpendicular to the third direction in accordance with the wavelength; a ninth element including a second dispersive element for generating multiplexed light by multiplexing the dispersed lights; a tenth element including eleventh and twelfth elements and converting the aspect ratio of the beam spot of the multiplexed light; an eleventh element including sixth and seventh optical power elements for converging the multiplexed light in a fourth plane extending in the propagation direction of the light and the fourth direction; a twelfth element including an eighth optical power element for converging the multiplexed light in the third plane; a thirteenth element including an output port for outputting the multiplexed light.

### BRIEF DESCRIPTION OF DRAWINGS

FIG. 1 is a schematic diagram showing a first embodiment of an optical device according to an aspect of the present invention.

FIG. 2 is a schematic diagram showing a modification of the optical device shown in FIG. 1.

FIG. 3 is a schematic diagram showing a second embodiment of the optical device according to an aspect of the present invention.

FIG. 4 is a schematic diagram showing a modification of the optical device shown in FIG. 3.

### DESCRIPTION OF EMBODIMENTS

Hereinafter, an embodiment of an optical device according to an aspect of the present invention will be described in detail with reference to the drawings. In the description of the drawings, the same reference signs are attached to the same components or equivalent components to omit a duplicate description.

### First Embodiment

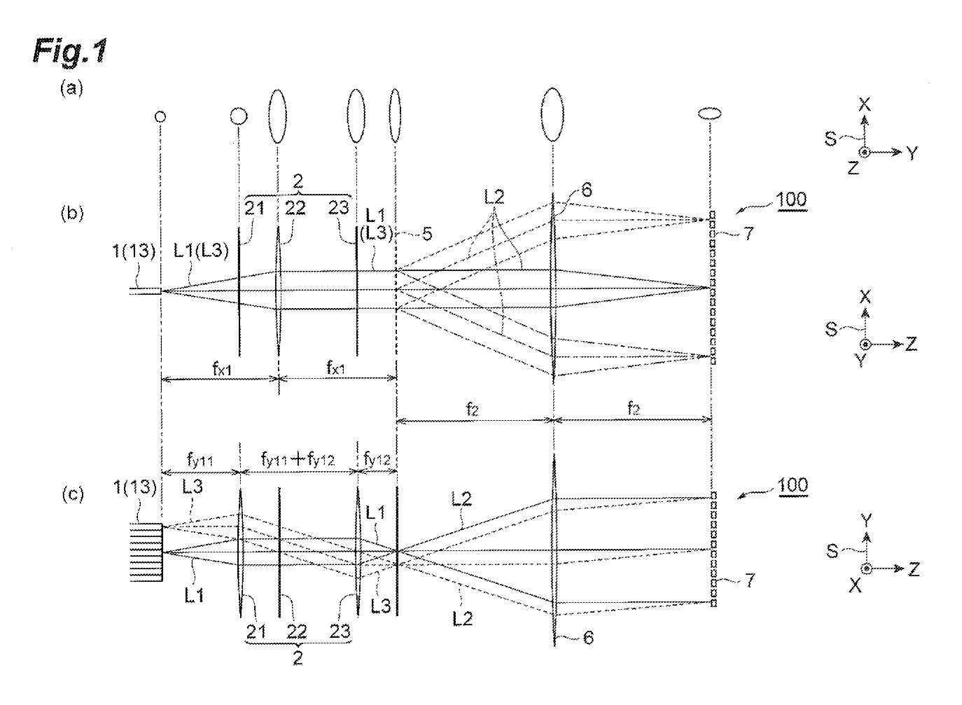

FIG. 1 is a schematic diagram showing a first embodiment of an optical device according to an aspect of the present invention. In FIG. 1, an orthogonal coordinate system S is shown. FIG. 1(a) shows beam spots of light propagating through the optical device when viewed from the z-axis direction of the orthogonal coordinate system S. FIG. 1(b) is a side view of the optical device when viewed from the y-axis direction of the orthogonal coordinate system S. FIG. 1(c) is a side view of the optical device when viewed from the x-axis direction of the orthogonal coordinate system S.

An optical path control device 100 according to the present embodiment includes an input port 1, an anamorphic converter 2, a dispersive element 5, an optical power element 6, a light deflection element 7, and an output port 13. Light input from the input port 1 is deflected by the light deflection element 7 after passing through the anamorphic converter 2, the dispersive element 5, and the optical power element 6 in this order, and then output from the output port 13 after passing through the optical power element 6, the dispersive element 5, and the anamorphic converter 2 in this order.

The optical power element here is, for example, a transmission-type element such as a spherical lens and a cylindrical lens or a reflection-type element such as a spherical mirror and a concave mirror and an element having optical power in at least one direction. The optical power is the capability to converge/collimate light passing through the optical power element (that is, the capability to change the optical path). Here, the optical power becomes larger as the focal position of the optical power element becomes closer. The optical power element is shown like a convex lens in a plane having optical power and like a straight line in a plane having no optical power.

The input port 1 and the output port 13 are arranged along the y-axis direction (first direction) and constitute an input/output port array. The number of each of the input port 1 and the output port 13 may be one or two or more. Wavelength multiplexed light L1 is input from the input port 1. The input port 1 constitutes a first element of the optical device according to an aspect of the present invention. The output port 13 constitutes a thirteenth element of the optical device according to an aspect of the present invention.

The anamorphic converter 2 allows the wavelength multiplexed light L1 input from the input port 1 to enter, convert the aspect ratio of beams spots of the wavelength multiplexed light L1, and emits wavelength multiplexed light L1. More specifically, the anamorphic converter 2 is arranged at front stage of the dispersive element 5, and converts the aspect ratio of beam spots of the wavelength multiplexed light L1 such that the spot size in the x-axis direction (second direction) of the wavelength multiplexed light L1 becomes larger than the spot size in the y-axis direction. The anamorphic converter 2 constitutes a second element of the optical device according to an aspect of the present invention.

The anamorphic converter 2 includes three optical power elements 21 to 23. The optical power elements 21 to 23 are arranged on the optical path from the input port 1 to the dispersive element 5 in this order. The wavelength multiplexed light L1 propagating while expanding from the input port 1 is incident on the optical power element 21, and the optical power element 21 collimates the wavelength multiplexed light L1 in a y-z plane (first plane) extending in the propagation direction of the wavelength multiplexed light L1 and the y-axis direction.

In an x-z plane (second plane) extending in the propagation direction of the wavelength multiplexed light L1 and the x-axis direction, on the other hand, the optical power element 21 maintains the expansion of the wavelength multiplexed light L1. That is, the optical power element 21 has optical power in the y-z plane and no optical power in the x-z plane. The optical power element 21 may be a cylindrical lens.

The wavelength multiplexed light L1 emitted from the optical power element 21 is incident on the optical power element 22 and the optical power element 22 collimates the wavelength multiplexed light L1 in the x-z plane. In the y-z plane, on the other hand, the optical power element 22 maintains the collimation of the wavelength multiplexed light L1. That is, the optical power element 22 has optical power in the x-z plane and no optical power in the y-z plane. The optical power element 22 may be a cylindrical lens.

The wavelength multiplexed light L1 emitted from the optical power element 22 is incident on the optical power element 23, and the optical power element 23 converges the wavelength multiplexed light L1 in the y-z plane. In the x-z plane, on the other hand, the optical power element 23 maintains the collimation of the wavelength multiplexed light L1. That is, the optical power element 23 has optical power in the y-z plane and no optical power in the x-z plane. The optical power element 23 may be a cylindrical lens.

Thus, the optical power elements 21, 23 converge the wavelength multiplexed light L1 in the y-z plane and the optical power element 22 collimates the wavelength multiplexed light L1 in the x-z plane. As a result, the wavelength multiplexed light L1 has a larger spot size in the x-axis direction than a spot size in the y-axis direction at a front side of the dispersive element 5.

The optical power elements 21, 23 correspond to first and second optical power elements of the optical device according to an aspect of the present invention and constitute a third element. The optical power element 22 corresponds to a third optical power element of the optical device according to an aspect of the present invention and constitute a fourth element. The optical power of the optical power element 21 and the optical power of the optical power element 23 are mutually equal. The optical power element 22 is arranged in a confocal position of the optical power element 21 and the optical power element 23.

The dispersive element 5 is arranged at the focal point of the optical power element 23 in the y-z plane. In the x-z plane, the dispersive element 5 generates a plurality of dispersed lights L2 in the x-z plane by rotating the propagation direction of the wavelength multiplexed light L1 around an axis along the y-axis direction in accordance with each wavelength. The dispersive element 5 disperses the wavelength multiplexed light L1 into the plurality of dispersed lights L2 along the x-axis direction and emits the dispersed lights in the x-z plane. The dispersive element 5 may be a diffraction grating and constitutes a fifth element of the optical device according to an aspect of the present invention.

The optical power element 6 converges each of the dispersed lights L2 and making the propagation directions of the plurality of dispersed lights L2 parallel in the x-z plane. On the other hand, the optical power element 6 collimates each of the dispersed lights L2 in the y-z plane. Accordingly, the beam spot of each of the dispersed lights L2 incident on the light deflection element 7 presents a ellipsoidal shape relatively larger in the y-axis direction than in the x-axis direction. Thus, the optical power element 6 has optical power in both of the x-z plane and the y-z plane. The optical power element 6 may be a spherical lens. The optical power element 6 constitutes a sixth element of the optical device according to an aspect of the present invention.

The light deflection element 7 is arranged in the condensing position of the dispersed lights L2 (focal point of the optical power element 6) in the x-z plane. The plurality of dispersed lights L2 emitted from the optical power element 6 enters the light deflection element 7 arranged along the x-axis direction.

The light deflection element 7 independently phase-modulates each of the dispersed lights L2. Accordingly, the light deflection element 7 deflects each of the dispersed lights L2 in the y-z plane by rotating the propagation direction around an axis along x-axis direction (third direction) perpendicular to the y-axis direction. The light deflection element 7 deflects the dispersed lights L2 in a direction substantially opposite to the incident direction of the dispersed lights L2.

The light deflection element 7 includes a plurality of pixelized light deflection elements arranged two-dimensionally in the x-axis direction and the y-axis direction. The light deflection element 7 may be LCOS or DMD (Digiral Micromirror Device). The light deflection element 7 constitutes a seventh element of the optical device according to an aspect of the present invention.

As described above, the light deflected by the light deflection element 7 passes through the optical power element 6, the dispersive element 5, and the anamorphic converter 2 in this order and then output from the output port 13. The optical power element 6 deflects, in x-z plane (a third plane) that extends in the propagation direction of the dispersed lights L2 and the x-axis direction (third direction), each of the dispersed lights L2 emitted from the light deflection element 7 by rotating around an axis along the y-axis direction (a fourth direction) perpendicular to the x-axis direction in accordance with the wavelength. Accordingly, each of the dispersed lights L2 emitted from the light deflection element 7 is condensed to a predetermined position of the dispersive element 5 in the x-axis direction.

On the other hand, the optical power element 6 converges each of the dispersed lights L2 emitted from the light deflection element 7 in the y-z plane. Accordingly, each of the dispersed lights L2 emitted from the light deflection element 7 is condensed onto the dispersive element 5 in the y-axis direction. The optical power element 6 corresponds to a fifth optical power element of the optical device according to an aspect of the present invention and constitute an eighth element.

The dispersive element 5 generates multiplexed light L3 by multiplexing the dispersed lights L2 in the in the x-z plane The dispersive element 5 constitutes a ninth element of the optical device according to an aspect of the present invention.

The multiplexed light L3 emitted from the dispersive element 5 is incident on the anamorphic converter 2, and the anamorphic converter 2 converts the aspect ratio of the beam spot, and emits the multiplexed light L3. More specifically, the anamorphic converter 2 converts the aspect ratio of the beam spot of the multiplexed light L3 such that the spot size in the y-axis direction of the multiplexed light L3 and the spot size in the x-axis direction are substantially equal between the dispersive element 5 and the output port 13. The anamorphic converter 2 constitutes a tenth element of the optical device according to an aspect of the present invention.

The anamorphic converter 2 includes, as described above, the optical power elements 23, 22, 21 and the optical power elements 23, 22, 21 are arranged on the optical path from the dispersive element 5 to the output port 13 in this order. The optical power element 23 collimates the multiplexed light L3 in the y-z plane. On the other hand, the optical power element 23 maintains the collimation of the multiplexed light L3 in the x-z plane.

The optical power element 22 converges the multiplexed light L3 in the x-z plane. On the other hand, the optical power element 22 maintains the collimation of the multiplexed light L3 in the y-z plane.

The optical power element 21 converges the multiplexed light L3 in the y-z plane. On the other hand, the optical power element 21 maintains the convergence of the multiplexed light L3 in the x-z plane.

Thus, the optical power elements 23, 21 converge the multiplexed light L3 in the y-z plane and the optical power element 22 converges the multiplexed light L3 in the x-z plane. As a result, the multiplexed light L3 has the substantially equal spot size in the y-axis direction and the x-axis direction that at the front side of the output port 13 and is coupled to the output port 13.

The optical power elements 23, 21 correspond to sixth and seventh optical power elements of the optical device according to an aspect of the present invention and constitute an eleventh element. The optical power element 22 corresponds to an eighth optical power element of the optical device according to an aspect of the present invention and constitute a twelfth element.

The positional relationship of each element of the optical path control device 100 will briefly be described. In the x-z plane, the distance from the input port 1 (output port 13) to the optical power element 22 and the distance from the optical power element 22 to the dispersive element 5 are set to be fₓ₁ and equal to each other. Also, the distance from the dispersive element 5 to the optical power element 6 and the distance from the optical power element 6 to the light deflection element 7 are set to be f₂ and equal to each other. In the y-z plane, when the distance from the input port 1 (output port 13) to the optical power element 21 is set to be f_{y11} and the distance from the optical power element 23 to the dispersive element 5 is set to be f_{y12}, the distance between the optical power element 21 and the optical power element 23 is set to be (f_{y11}+f_{y12}).

In the optical path control device 100, as described above, the wavelength multiplexed light L1 from the input port 1 is converged in the y-axis direction and collimated in the x-axis direction by the anamorphic converter 2. That is, the beam spot of the wavelength multiplexed light L1 from the input port 1 is converted by the anamorphic converter 2 into a flat shape relatively larger in the x-axis direction than in the y-axis direction. Then, the wavelength multiplexed light L2 emitted from the anamorphic converter 2 and having a ellipsoidal shape is rotated around an axis along the y-axis direction by the dispersive element 5 in accordance with the wavelength so as to be dispersed into the plurality of dispersed lights L2.

Then, each of the dispersed lights L2 propagating while the beam spot thereof expands in the y-axis direction, and being converged in the x-axis direction by the optical power element 6 is incident on the light deflection element 7. Accordingly, the spot size of the dispersed lights L2 incident on the light deflection element 7 is larger in the y-axis direction than in the x-axis direction (that is, the aspect ratio is reversed by the optical power element 6). The light deflection element 7 deflects the dispersed lights L2 by light deflection component elements (pixels) arranged in the y-axis direction.

Thus, since the dispersed lights L2 having the larger spot size in the phase-modulating direction (y-axis direction) of the light deflection component elements, the dispersed lights L2 can be deflected precisely and efficiently. Particularly since the spot size is converted at the front side of the dispersive element 5, the freedom of optical design may be enhanced.

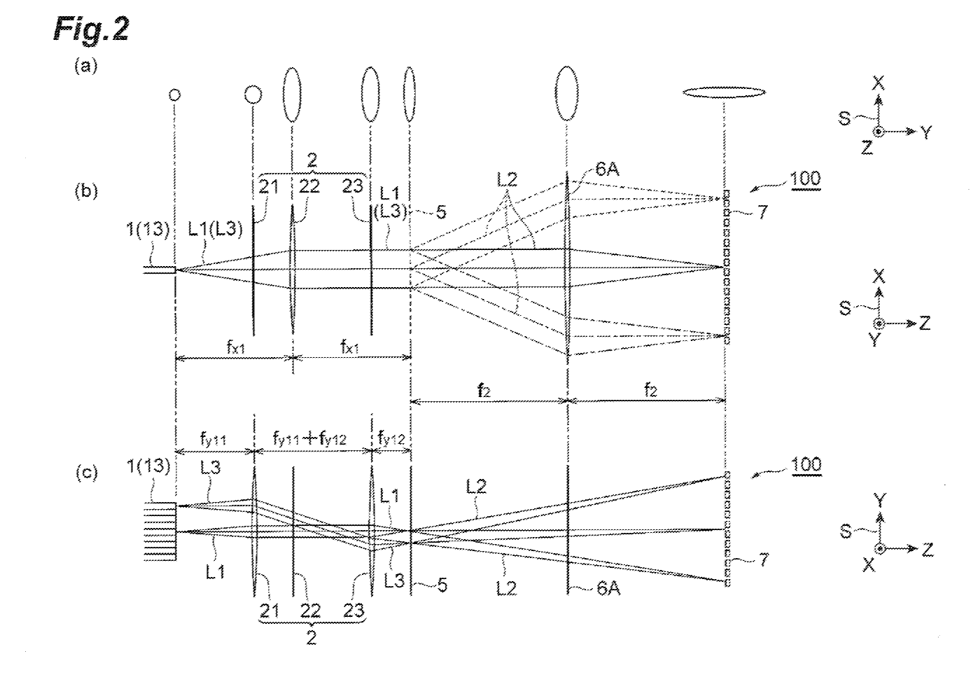

As shown in FIG. 2, an optical power element 6A may be used instead of the optical power element 6. The optical power element 6A is, for example, a cylindrical lens and has optical power in the x-z plane.

That is, the optical power element 6A converges each of the dispersed lights L2 and making the propagation directions of the plurality of dispersed lights L2 parallel in the x-z plane. On the other hand, the optical power element 6A maintains the expansion of the dispersed lights L2 in the y-z plane. That is, the optical power element 6A converges each of the dispersed lights L2 only in the x-axis direction, and expands the spot size of the dispersed lights L2 in the y-axis direction. Thus, the aspect ratio of the beam spot of each of the dispersed lights L2 incident on the light deflection element 7 is expanded and more light deflection component elements of the light deflection element 7 can be made to contribute to deflect the dispersed lights L2. Therefore, the dispersed lights L2 may be deflected more efficiently.

### Second Embodiment

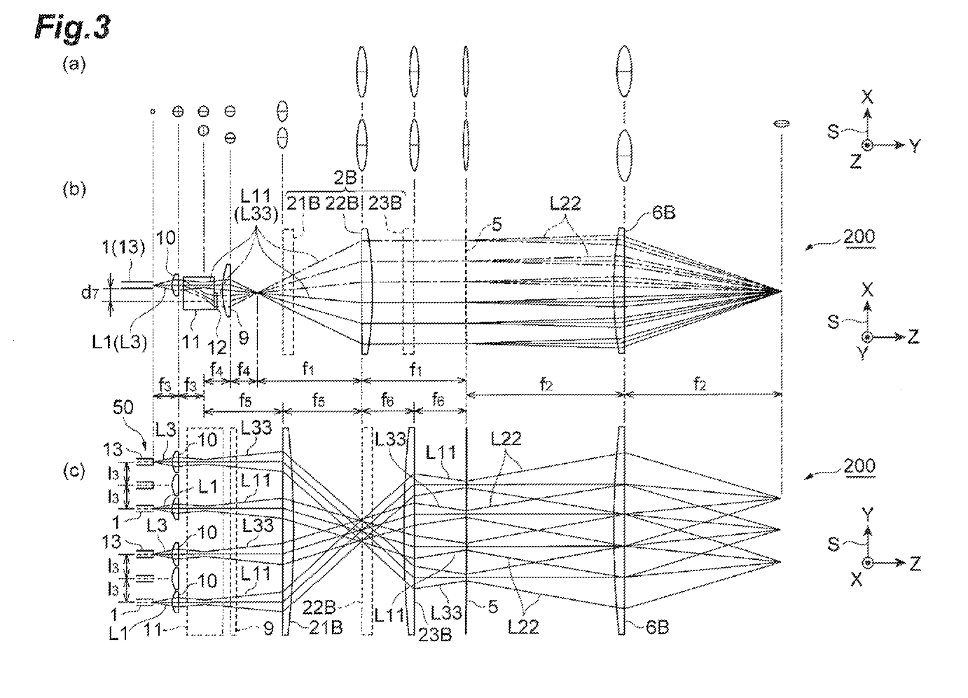

FIG. 3 shows a second embodiment of the optical device according to an aspect of the present invention. In FIG. 3, an orthogonal coordinate system S is shown. FIG. 3(a) shows beam spots of light propagating through the optical path control device when viewed from the z-axis direction and the deflection direction is indicated by internal straight lines. FIG. 3(b) is a side view of the optical path control device when viewed from the y-axis direction. FIG. 3(c) is a side view of the optical path control device when viewed from the x-axis direction. An optical power element is shown by a solid line in a plane having optical power and by a broken line in a plane having no optical power.

An optical path control device 200 according to the present embodiment is different from the optical path control device 100 according to the first embodiment in that an anamorphic converter 2B is included, instead of the anamorphic converter 2, and an optical power element 6B is included instead of the optical power element 6, and optical power elements 9, 10, a polarization separation element 11, and a half-wave plate 12 are further included. In the optical path control device 200, the input/output array 50 includes at least one input port 1 and at least one output port 13. The optical path control device 200 includes at least the two input/output arrays 50 for inputting the wavelength multiplexed light L1 from the respective input ports 1, and outputting the multiplexed light L3 from the respective output ports 13.

Each optical power elements 10 is arranged in the y-axis direction (first direction) so as to correspond to the input port 1 and the output port 13. The optical power element 10 converges the wavelength multiplexed light L1 input from input port 1 in the x-z plane and in the y-z plane. The optical power element 10 may be a convex lens.

The polarization separation element 11 is arranged at a rear side of the optical power element 10 and at a front side of the anamorphic converter 2B. The polarization separation element 11 separates the wavelength multiplexed light L1 into two polarization components L11 in the x-z plane in accordance with the polarization state. The half-wave plate 12 is disposed on an emission surface of the polarization separation element 11 from which the polarization component L11 emit. The half-wave plate 12 makes the polarization state of one of the polarization components L11 substantially the same with the polarization state of the other polarization component, and then emits the polarization components. Therefore, the polarization components L11 whose polarization state are the same with each other enter the anamorphic converter 2B.

The optical power element 9 is arranged at a rear side of the polarization separation element 11 and the half-wave plate 12, and at a front side of the anamorphic converter 2B. The optical power element 9 expands the beam spot of the polarization component L11 in the x-z plane so as to expands the beam spot of the wavelength multiplexed light L11 in the x-z plane when entering the anamorphic converter 2B by temporarily forming an image of the polarization component L11 before the anamorphic converter 2B. On the other hand, the optical power element 9 has no optical power in the y-z plane. The optical power element 9 may be a cylindrical lens. The optical power element 9 corresponds to a ninth power element of the optical device according to an aspect of the present invention.

The polarization components L11 emitted from the optical power element 9 is incident on the anamorphic converter 2B, and the anamorphic converter 2B converts the aspect ratio of the beam spots, and emits the polarization components L11. More specifically, at a front side of the dispersive element 5, the anamorphic converter 2B converts the aspect ratio of beam spots of the polarization component L11 such that the spot size in the x-axis direction of the wavelength multiplexed lights L11 becomes larger than the spot size in the y-axis direction. The anamorphic converter 2B constitutes the second element of the optical device according to an aspect of the present invention.

The anamorphic converter 2B includes three optical power elements 21B to 23B. The optical power elements 21B to 23B are arranged on the optical path from the input port 1 to the dispersive element 5 in this order. The polarization components L11 emitted from the optical power element 9 incident on the optical power element 21B, and the optical power element 21B collimates the polarization components L11 in y-z the plane and rotates the polarization components L11 around an axis along the x-axis direction.

In the x-z plane, on the other hand, the optical power element 21B maintains the expansion of the polarization components L11. That is, the optical power element 21B has optical power in the y-z plane and no optical power in the x-z plane. The optical power element 21B may be a cylindrical lens.

The polarization components L11 emitted from the optical power element 21B incident on the optical power element 22B, and the optical power element 21B collimates the polarization components L11 in the x-z plane. In the y-z plane, on the other hand, the optical power element 22B maintains the collimation of the polarization components L11. That is, the optical power element 22B has optical power in the x-z plane and no optical power in the y-z plane. The optical power element 22B may be a cylindrical lens.

The polarization components L11 emitted from the optical power element 22B is incident on the optical power element 23B, and makes the propagation directions of the polarization components L11 parallel and converges the polarization components L11 in the y-z plane. In the x-z plane, on the other hand, the optical power element 23B maintains the collimation of the wavelength multiplexed lights L11. That is, the optical power element 23B has optical power in the y-z plane and no optical power in the x-z plane. The optical power element 23B may be a cylindrical lens.

Thus, the optical power elements 21B, 23B converge the polarization components L11 in the y-z plane and the optical power element 22B collimates the polarization components L11 in the x-z plane. As a result, each of the polarization components L11 has a larger spot size in the x-axis direction than in the y-axis direction at a front side of the dispersive element 5.

The optical power elements 21B, 23B correspond to the first and second optical power elements of the optical device according to an aspect of the present invention and constitute the third element. The optical power element 22B corresponds to the third optical power element of the optical device according to an aspect of the present invention and constitute the fourth element. Incidentally, the optical power of the optical power element 21B and the optical power of the optical power element 23B are mutually equal. Also, the optical power element 22B is arranged in a confocal position of the optical power element 21B and the optical power element 23B.

Like in the first embodiment, the dispersive element 5 disperses each of the polarization components L11 emitted from the anamorphic converter 2B along the x-axis direction so as to generate dispersed lights L22. The optical power element 6B makes the propagation directions of the dispersed lights L22 parallel in the x-z plane such that respective wavelength components of the dispersed lights L22 may be incident on the light deflection element of substantially the same positions in the x-axis direction and the beam spot of each of the dispersed lights L2 presents an elliptical shape relatively larger in the y-axis direction than in the x-axis direction on a light deflection element.

The light deflection element (not shown) is the same as the light deflection element 7 according to the first embodiment. The light deflected by the light deflection element passes through the optical power element 6B, the dispersive element 5, the anamorphic converter 2B, the optical power element 9, the polarization separation element 11 (or the half-wave plate 12 and the polarization separation element 11), and the optical power element 10 in this order before being output from the output port 13.

The optical power element 6B deflects, in the x-z plane (third plane) that extends in the propagation direction of dispersed lights L22 and the x-axis direction (third direction), each of the dispersed lights L22 emitted from the light deflection element by rotating around an axis along the y-axis direction (fourth direction) in accordance with the wavelength.

The optical power element 6B converges each of the dispersed lights L2 emitted from the light deflection element in the y-z plane. Accordingly, each of the dispersed lights L2 emitted from the light deflection element is condensed, in the y-axis direction, onto the dispersive element 5. The optical power element 6B corresponds to the fifth optical power element of the optical device according to an aspect of the present invention and constitute the eighth element.

The dispersive element 5 generates multiplexed light L33 by multiplexing one or more of the dispersed lights L22 in the x-z plane. The multiplexed light L33 is generated as a pair in accordance with the wavelength multiplexed lights L11 separated by the polarization separation element 11. The dispersive element 5 corresponds to the second dispersive element of the optical device according to an aspect of the present invention and constitutes the ninth element.

The multiplexed light L3 is incident on the anamorphic converter 2B, and the anamorphic converter 2B converts the aspect ratio of the beam spot of the multiplexed light L3 such that the spot size in the y-axis direction and the spot size in the x-axis direction are substantially equal between the dispersive element 5 and the output port 13. The anamorphic converter 2B constitutes the tenth element of the optical device according to an aspect of the present invention.

The anamorphic converter 2B includes, as described above, the optical power elements 23B, 22B, 21B, and the optical power elements 23B, 22B, 21B are arranged on the optical path from the dispersive element 5 to the output port 13 in this order. The optical power element 23B collimates the multiplexed lights L33 in y-z the plane and rotates the propagation direction each of the multiplexed light L33 around an axis along the x-axis direction. On the other hand, the optical power element 23B maintains the collimation of the multiplexed light L33 in the x-z plane.

The optical power element 22B converges the multiplexed light L33 in the x-z plane. On the other hand, the optical power element 22B maintains the collimation of the multiplexed light L33 in the y-z plane.

The optical power element 21B converges the multiplexed light L33 in the y-z plane. On the other hand, the optical power element 21B maintains the convergence of the multiplexed light L3 in the x-z plane.

Thus, the optical power elements 23B, 21B converge the multiplexed light L33 in y-z the plane, and the optical power element 22B converges the multiplexed light L33 in the x-z plane. As a result, at a front side of the output port 13 (more specifically, at a front side of the optical power element 9), the multiplexed light L33 has substantially equal spot size in the y-axis direction and the x-axis direction.

The optical power elements 23B, 21B correspond to the sixth and seventh optical power elements of the optical device according to an aspect of the present invention and constitute the eleventh element. The optical power element 22B corresponds to the eighth optical power element of the optical device according to an aspect of the present invention and constitute the twelfth element.

The multiplexed light L33 is incident on the polarization separation element 11 after passing through the optical power element 9. One of the multiplexed lights L33 directly enters the polarization separation element 11 and the other enters the polarization separation element 11 after passing through the half-wave plate 12. The multiplexed lights L33 are combined and emitted from the polarization separation element 11 as the multiplexed light L3. The multiplexed light L3 is condensed by the optical power element 10 so as to being coupled to the output port 13.

The positional relationship of each element of the optical path control device 200 will briefly be described. When the distance from the input port 1 (output port 13) to the optical power element 10 is set to be f₃, and focal length of the optical power element 9 is set to be f₄, the distance from the center position of the polarization separation element 11 to the optical power element 10 is set to be f₃, the distance between the center position of the polarization separation element 11 and the optical power element 9 is set to be f₄. Distance from focal point of the optical power element 9 to the optical power element 22B is set to be f₁ (focal length), the distance from the optical power element 22B to the dispersive element 5 is also set to be f₁. The positional relationship between the dispersive element 5, the optical power element 6B, and the light deflection element is the same as the positional relationship between the dispersive element 5, the optical power element 6, and the light deflection element 7 in the first embodiment.

The distance from the center position of the polarization separation element 11 to the optical power element 21b, and the distance from the optical power element 21B to the optical power element 22B are set to be f₅ and substantially equal to each other. Further, the distance from the optical power element 22B to the optical power element 23B, and the distance from the optical power element 23B to the dispersive element 5 are set to be f₆ and substantially equal to each other. In addition, a center axis of separation, in the x-z plane, of the wavelength multiplexed light L1 coincides with the optical axis of the wavelength multiplexed light L1 in the x-axis direction. The distance between ports in the input/output array 50 is 1₃ and substantially equal to each other.

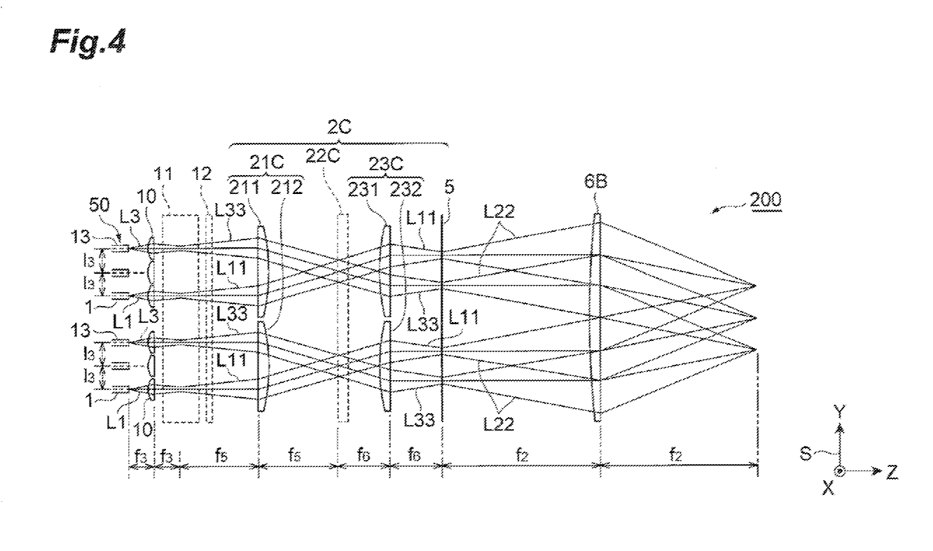

As shown in FIG. 4, an anamorphic converter 2C can be used instead of the anamorphic converter 2B. The anamorphic converter 2C includes optical power elements 21C to 23C instead of the optical power elements 21B to 23B. The optical power elements 21C to 23C have similar functions of the optical power elements 21B to 23B respectively and include a plurality of lens regions (for example, lens regions 211, 212 and lens regions 231, 232) arranged by being divided along the y-axis direction. Each of the lens regions 211, 212, 231, 232 configured to be associated with at least one of the input port 1 and/or output port 13. More specifically, the lens region 212 of the optical power element 21C and the lens region 231 of the optical power element 23C (alternatively, the lens region 212 of the optical power element 21C and the lens region 232 of the optical power element 23C) are associated with a first predetermined number (for example, one) of the input ports 1 and a second predetermined number (for example, one) of the output ports 13.

Thus, by using the lens regions 211, 212, 231, 232, the wavelength multiplexed light L11 passing outside edge of the optical power element 21C, 23C may be reduced, and also the multiplexed lights L33 passing outside edge of the optical power element 21C, 23C may be reduced, and therefore, aberration in the y-axis direction may be suppressed.

The above embodiments describe an embodiment of the optical device according to an aspect of the present invention. Therefore, the optical device according to an aspect of the present invention are not limited to the optical path control devices 100, 200 described above and may be any modification of the optical path control devices 100, 200 without altering the spirit of each claim.

### INDUSTRIAL APPLICABILITY

An optical device for deflecting light precisely and efficiently and also enhancing freedom of optical design can be provided.

### REFERENCE SIGNS LIST

100, 200: Optical path control device, 1: Input port (first element), 2, 2B, 2C: Anamorphic converter (second element), 5: Dispersive element (first and second dispersive elements, fifth and ninth elements), 6: Optical power element (fourth and fifth optical power elements, sixth element), 7: Light deflection element (seventh element), 11: Polarization separation element, 13: Output port (thirteenth element), 21, 21B, 21C: Optical power element (first and sixth optical power elements, third and eleventh elements), 22, 22B, 22C: Optical power element (third and eighth optical power elements, fourth and twelfth elements), 23, 23B, 23C: Optical power element (second and seventh optical power elements, third and eleventh elements)

1. An optical device comprising:
a first element including an input port for inputting wavelength multiplexed light;
a second element including third and fourth elements and converting an aspect ratio of a beam spot of the wavelength multiplexed light;
the third element including first and second optical power elements for converging the wavelength multiplexed light in a first plane that extends in a propagation direction of the light and a first direction;
the fourth element including a third optical power element for collimating the wavelength multiplexed light in a second plane that extends in the propagation direction of the light and a second direction perpendicular to the first direction;
a fifth element generating a plurality of dispersed lights in the second plane by rotating the propagation direction of light around an axis along the first direction in accordance with each wavelength;
a sixth element including a fourth optical power element for converging each of the dispersed lights and making the propagation directions of the plurality of dispersed lights parallel in the second plane;
a seventh element deflecting each of the dispersed lights in the first plane by rotating the propagation direction around an axis along a third direction perpendicular to the first direction, and including a plurality of pixelized light deflection elements arranged in the first direction for independently modulating each of the dispersed lights;
an eighth element including a fifth optical power element for deflecting, in a third plane that extends in the propagation direction of the light and the third direction, each of the dispersed lights emitted from the seventh element by rotating around an axis along a fourth direction perpendicular to the third direction in accordance with the wavelength;
a ninth element including a second dispersive element for generating multiplexed light by multiplexing the dispersed lights;
a tenth element including eleventh and twelfth elements and converting the aspect ratio of the beam spot of the multiplexed light;
an eleventh element including sixth and seventh optical power elements for converging the multiplexed light in a fourth plane extending in the propagation direction of the light and the fourth direction;
a twelfth element including an eighth optical power element for converging the multiplexed light in the third plane;
a thirteenth element including an output port for outputting the multiplexed light; and
wherein the third optical power element is arranged in a confocal position of the first and second optical power elements, or
the eighth optical power element is arranged in a confocal position of the sixth and seventh optical power elements.

2. (canceled)

3. (canceled)

4. An optical device comprising:
a first element including an input port for inputting wavelength multiplexed light;
a second element including third and fourth elements and converting an aspect ratio of a beam spot of the wavelength multiplexed light;
the third element including first and second optical power elements for converging the wavelength multiplexed light in a first plane that extends in a propagation direction of the light and a first direction;
the fourth element including a third optical power element for collimating the wavelength multiplexed light in a second plane that extends in the propagation direction of the light and a second direction perpendicular to the first direction;
a fifth element generating a plurality of dispersed lights in the second plane by rotating the propagation direction of the light around an axis along the first direction in accordance with each wavelength;
a sixth element including a fourth optical power element for converging each of the dispersed lights and making the propagation directions of the plurality of dispersed lights parallel in the second plane;
a seventh element deflecting each of the dispersed lights in the first plane by rotating the propagation direction around an axis along a third direction perpendicular to the first direction, and including a plurality of pixelized light deflection elements arranged in the first direction for independently modulating each of the dispersed lights;
an eighth element including a fifth optical power element for deflecting, in a third plane that extends in the propagation direction of the light and the third direction, each of the dispersed lights emitted from the seventh element by rotating around an axis along a fourth direction perpendicular to the third direction in accordance with the wavelength;
a ninth element including a second dispersive element for generating multiplexed light by multiplexing the dispersed lights;
a tenth element including eleventh and twelfth elements and converting the aspect ratio of the beam spot of the multiplexed light;
an eleventh element including sixth and seventh optical power elements for converging the multiplexed light in a fourth plane extending in the propagation direction of the light and the fourth direction;
a twelfth element including an eighth optical power element for converging the multiplexed light in the third plane;
a thirteenth element including an output port for outputting the multiplexed light;
wherein the third optical power element is arranged in a confocal position of the first and second optical power elements, or
the eighth optical power element is arranged in a confocal position of the sixth and seventh optical power elements;
wherein the fourth optical power element is a cylindrical lens for converging each of the dispersed lights only in the second direction and expanding a spot size in the first direction of the dispersed lights incident on the seventh element.

5. An optical device comprising:
a first element including an input port for inputting wavelength multiplexed light;
a second element including third and fourth elements and converting an aspect ratio of a beam spot of the wavelength multiplexed light;
the third element including first and second optical power elements for converging the wavelength multiplexed light in a first plane that extends in a propagation direction of the light and a first direction;
the fourth element including a third optical power element for collimating the wavelength multiplexed light in a second plane that extends in the propagation direction of the light and a second direction perpendicular to the first direction;
a fifth element generating a plurality of dispersed lights in the second plane by rotating the propagation direction of the light around an axis along the first direction in accordance with each wavelength;
a sixth element including a fourth optical power element for converging each of the dispersed lights and making the propagation directions of the plurality of dispersed lights parallel in the second plane;
a seventh element deflecting each of the dispersed lights in the first plane by rotating the propagation direction around an axis along a third direction perpendicular to the first direction, and including a plurality of pixelized light deflection elements arranged in the first direction for independently modulating each of the dispersed lights;
an eighth element including a fifth optical power element for deflecting, in a third plane that extends in the propagation direction of the light and the third direction, each of the dispersed lights emitted from the seventh element by rotating around an axis along a fourth direction perpendicular to the third direction in accordance with the wavelength;
a ninth element including a second dispersive element for generating multiplexed light by multiplexing the dispersed lights;
a tenth element including eleventh and twelfth elements and converting the aspect ratio of the beam spot of the multiplexed light;
an eleventh element including sixth and seventh optical power elements for converging the multiplexed light in a fourth plane extending in the propagation direction of the light and the fourth direction;
a twelfth element including an eighth optical power element for converging the multiplexed light in the third plane;
a thirteenth element including an output port for outputting the multiplexed light; wherein at least one of the first to third optical power elements including a plurality of lens regions arranged by being divided along the first direction and one of the lens regions is associated with the input port, or
wherein at least one of the sixth to eighth optical power elements including a plurality of lens regions arranged by being divided along the fourth direction and one of the lens regions is associated with the output port.

6. (canceled)

7. An optical device comprising:
a first element including an input port for inputting wavelength multiplexed light;
a second element including third and fourth elements and converting an aspect ratio of a beam spot of the wavelength multiplexed light;
the third element including first and second optical power elements for converging the wavelength multiplexed light in a first plane that extends in a propagation direction of the light and a first direction;
the fourth element including a third optical power element for collimating the wavelength multiplexed light in a second plane that extends in the propagation direction of the light and a second direction perpendicular to the first direction;
a fifth element generating a plurality of dispersed lights in the second plane by rotating the propagation direction of the light around an axis along the first direction in accordance with each wavelength;
a sixth element including a fourth optical power element for converging each of the dispersed lights and making the propagation directions of the plurality of dispersed lights parallel in the second plane;
a seventh element deflecting each of the dispersed lights in the first plane by rotating the propagation direction around an axis along a third direction perpendicular to the first direction, and including a plurality of pixelized light deflection elements arranged in the first direction for independently modulating each of the dispersed lights;
an eighth element including a fifth optical power element for deflecting, in a third plane that extends in the propagation direction of the light and the third direction, each of the dispersed lights emitted from the seventh element by rotating around an axis along a fourth direction perpendicular to the third direction in accordance with the wavelength;
a ninth element including a second dispersive element for generating multiplexed light by multiplexing the dispersed lights;
a tenth element including eleventh and twelfth elements and converting the aspect ratio of the beam spot of the multiplexed light;
an eleventh element including sixth and seventh optical power elements for converging the multiplexed light in a fourth plane extending in the propagation direction of the light and the fourth direction;
a twelfth element including an eighth optical power element for converging the multiplexed light in the third plane;
a thirteenth element including an output port for outputting the multiplexed light;
wherein optical power of the first optical power element and that of the second optical power element are mutually equal, or
optical power of the sixth optical power element and that of the seventh optical power element are mutually equal.

8. (canceled)

9. An optical device comprising:
a first element including an input port for inputting wavelength multiplexed light;
a second element including third and fourth elements and converting an aspect ratio of a beam spot of the wavelength multiplexed light;
the third element including first and second optical power elements for converging the wavelength multiplexed light in a first plane that extends in a propagation direction of the light and a first direction;
the fourth element including a third optical power element for collimating the wavelength multiplexed light in a second plane that extends in the propagation direction of the light and a second direction perpendicular to the first direction;
a fifth element generating a plurality of dispersed lights in the second plane by rotating the propagation direction of the light around an axis along the first direction in accordance with each wavelength;
a sixth element including a fourth optical power element for converging each of the dispersed lights and making the propagation directions of the plurality of dispersed lights parallel in the second plane;
a seventh element deflecting each of the dispersed lights in the first plane by rotating the propagation direction around an axis along a third direction perpendicular to the first direction, and including a plurality of pixelized light deflection elements arranged in the first direction for independently modulating each of the dispersed lights;
an eighth element including a fifth optical power element for deflecting, in a third plane that extends in the propagation direction of the light and the third direction, each of the dispersed lights emitted from the seventh element by rotating around an axis along a fourth direction perpendicular to the third direction in accordance with the wavelength;
a ninth element including a second dispersive element for generating multiplexed light by multiplexing the dispersed lights;
a tenth element including eleventh and twelfth elements and converting the aspect ratio of the beam spot of the multiplexed light;
an eleventh element including sixth and seventh optical power elements for converging the multiplexed light in a fourth plane extending in the propagation direction of the light and the fourth direction;
a twelfth element including an eighth optical power element for converging the multiplexed light in the third plane;
a thirteenth element including an output port for outputting the multiplexed light;
wherein the ninth optical power element is further arranged at a front side of the first to third optical power elements to expand the spot size of the wavelength multiplexed light in the second plane;
thereby the wavelength multiplexed light is expanded by the ninth optical power element and collimated by the third optical power element, and incident on the fifth element, and incident on the seventh element such that an anamorphic ratio of each of the dispersed lights incident on the seventh element is reversed by that of incident on the fourth element.

10. The optical device according to claim 1, further comprising:
a polarization separation element arranged at a front side of the second element to separate the wavelength multiplexed light into polarization components in accordance with a polarization state, wherein
the polarization state of the polarization components incident on the second element being made substantially the same.

11. The optical device according to claim 10, wherein the polarization separation element separates the wavelength multiplexed light along the second direction.

12. The optical device according to claim 11, wherein a center axis of separation of the wavelength multiplexed light coincides with an optical axis of the wavelength multiplexed light in the second direction.

13. The optical device according to claim 4, further comprising:
a polarization separation element arranged at a front side of the second element to separate the wavelength multiplexed light into polarization components in accordance with a polarization state, wherein
the polarization state of the polarization components incident on the second element being made substantially the same.

14. The optical device according to claim 13, wherein the polarization separation element separates the wavelength multiplexed light along the second direction.

15. The optical device according to claim 14, wherein a center axis of separation of the wavelength multiplexed light coincides with an optical axis of the wavelength multiplexed light in the second direction.

16. The optical device according to claim 5, further comprising:
a polarization separation element arranged at a front side of the second element to separate the wavelength multiplexed light into polarization components in accordance with a polarization state, wherein
the polarization state of the polarization components incident on the second element being made substantially the same.

17. The optical device according to claim 16, wherein the polarization separation element separates the wavelength multiplexed light along the second direction.

18. The optical device according to claim 17, wherein a center axis of separation of the wavelength multiplexed light coincides with an optical axis of the wavelength multiplexed light in the second direction.

19. The optical device according to claim 7, further comprising:
a polarization separation element arranged at a front side of the second element to separate the wavelength multiplexed light into polarization components in accordance with a polarization state, wherein
the polarization state of the polarization components incident on the second element being made substantially the same.

20. The optical device according to claim 19, wherein the polarization separation element separates the wavelength multiplexed light along the second direction.

21. The optical device according to claim 20, wherein a center axis of separation of the wavelength multiplexed light coincides with an optical axis of the wavelength multiplexed light in the second direction.

22. The optical device according to claim 9, further comprising:
a polarization separation element arranged at a front side of the second element to separate the wavelength multiplexed light into polarization components in accordance with a polarization state, wherein
the polarization state of the polarization components incident on the second element being made substantially the same.

23. The optical device according to claim 22, wherein the polarization separation element separates the wavelength multiplexed light along the second direction.

24. The optical device according to claim 23, wherein a center axis of separation of the wavelength multiplexed light coincides with an optical axis of the wavelength multiplexed light in the second direction.
